(19) United States
(12) Patent Application Publication
(10) Pub. No.: US 2026/0361444 A1
(43) Pub. Date: Nov. 12, 2026

(54) ENHANCEMENT OF PHYSICAL LAYER SECURITY IN WIRELESS LINKS BY LONGITUDINALLY TAILORING THE NOISE POWER TO OVERWHELM THE SIGNAL POWER

(71) Applicant: University of Southern California, Los Angeles, CA (US)

(72) Inventors: Andreas Molisch, Los Angeles, CA (US); Xinzhou Su, Los Angeles, CA (US); Alan Willner, Los Angeles, CA (US)

(21) Appl. No.: 19/661,309

(22) Filed: Apr. 28, 2026

Related U.S. Application Data
(60) Provisional application No. 63/797,400, filed on Apr. 30, 2025.

(51) Int. Cl. H04K 1/02; H04B 10/25

(52) U.S. Cl. CPC H04K 1/02; H04B 10/25

(57) ABSTRACT

A system includes: a receiver configured to: receive a first signal including data to be communicated from the transmitter to the receiver, the first signal propagated along a first axis of propagation between the transmitter and the receiver in a longitudinal direction, and receive a second signal including artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

### CROSS-REFERENCE TO RELATED PATENT APPLICATION

This application claims the benefit of and priority to U.S. Provisional Application No. 63/797,400, filed Apr. 30, 2025, the entirety of which is incorporated by reference herein.

### STATEMENT REGARDING FEDERALLY SPONSORED RESEARCH OR DEVELOPMENT

This invention was made with government support under N00014-20-1-2558 awarded by the Office of Naval Research and FA9453-20-2-0001 awarded by the Air Force Office of Scientific Research. The government has certain rights in the invention.

### SUMMARY

The present disclosure describes a system in which noise is introduced into an electromagnetic signal to enhance security of communications to prevent an eavesdropper from determining or understanding a message encoded in the electromagnetic signal. The systems and methods described herein may be utilized for electromagnetic signals in any frequency ranges (including but not limited to an optical frequency range). For example, the system may include an optical beam transmitting data to a receiver, and an optical beam comprising artificial noise. The artificial noise may “bury” the data and prevent an eavesdropper from retrieving the data. This system can be utilized when a location of an eavesdropper is unknown and does not rely on the eavesdropper being positioned such that they are unable to receive a sufficient signal power to decode the data. Further, this technology provides advantages beyond cryptographic security based on the noise model described herein. The noise model allows for an analog security architecture that is resistant to cryptographic defeats and is resistant to quantum decryption. For example, this is due to brute-force techniques being less applicable.

One embodiment relates to a system including: a receiver configured to: receive a first signal comprising data to be communicated from the transmitter to the receiver, the first signal propagated along a first axis of propagation between the transmitter and the receiver in a longitudinal direction and receive a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

In some embodiments, the first signal and the second signal are co-propagated along the first axis. In some embodiments, the second signal is generated by superposing a plurality of beams, each of the plurality of beams having different longitudinal characteristics. In some embodiments, the plurality of beams includes a plurality of Bessel beams, and each of the plurality of Bessel beams includes a different longitudinal wavenumber.

In some embodiments, the second signal may be configured to generate an increased signal-to-artificial noise ratio within the region surrounding the location of the receiver relative to a signal-to-artificial noise ratio at other locations along the first axis by: generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, where the signal-to-artificial noise ratio is greater than a threshold value within the region surrounding the location of the receiver.

In some embodiments, a spatial structure of the second signal may be randomized by: modifying one or more transmission parameters of each of a plurality of beams comprising the second signal; and varying a relative amplitude of each of the plurality of beams comprising the second signal. In some embodiments, wherein a spatial profile of the first signal may be modulated by: varying one or more of: an amplitude or a transmission parameter of each of a plurality of beams comprising the first signal. In some embodiments, the receiver may be further configured to receive a third signal configured to generate an off-axis signal-to-artificial-noise ratio having a value less than a threshold value to prevent decoding of the first signal.

Another embodiment relates to a signal transmitter configured to: transmit a first signal comprising data to be communicated from the transmitter to a receiver, the first signal propagated along a first axis of propagation between the transmitter and the receiver in a longitudinal direction; and transmit a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

In some embodiments, the first signal and the second signal may be co-propagated along the first axis. In some embodiments, the second signal may be generated by superposing a plurality of beams, each of the plurality of beams having different longitudinal characteristics. In some embodiments, the plurality of beams includes a plurality of Bessel beams, and each of the plurality of Bessel beams includes a different longitudinal wavenumber.

In some embodiments, the second signal is configured to generate an increased signal-to-artificial noise ratio within the region surrounding the location of the receiver relative to a signal-to-artificial noise ratio at other locations along the first axis by: generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, wherein the signal-to-artificial noise ratio is greater than a threshold value within the region surrounding the location of the receiver.

In some embodiments, a spatial structure of the second signal may be randomized by: modifying one or more transmission parameters of each of a plurality of beams comprising the second signal; and varying a relative amplitude of each of the plurality of beams comprising the second signal. In some embodiments, wherein a spatial profile of the first signal may be modulated by: varying one or more of: an amplitude or a transmission parameter of each of a plurality of beams comprising the first signal.

Another embodiment relates to a method including: transmitting, by a transmitter, a first signal comprising data to be communicated from the transmitter to a receiver, the first signal propagated along a first axis of propagation between the transmitter and the receiver in a longitudinal direction; and transmitting, by the transmitter, a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

In some embodiments, the first signal and the second signal are co-propagated along the first axis. In some embodiments, the second signal may be generated by superposing a plurality of beams, each of the plurality of beams having different longitudinal characteristics.

In some embodiments, the method further includes: modulating a spatial profile of the first signal by: varying one or more of: an amplitude or a transmission parameter of each of a plurality of beams including the first signal; and randomizing a spatial structure of the second signal by: modifying one or more transmission parameters of each of a plurality of beams including the second signal; and varying a relative amplitude of each of the plurality of beams including the second signal.

In some embodiments, the method further includes: generating an increased signal-to-artificial noise ratio within the region surrounding the location of the receiver relative to a signal-to-artificial noise ratio at other locations along the first axis by: generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, where the signal-to-artificial noise ratio is greater than a threshold value within the region surrounding the location of the receiver.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 is a block diagram of a physical layer security (PLS) system, according to an exemplary embodiment.

FIG. 2 is a block diagram of the PLS system, according to an exemplary embodiment.

FIG. 3 is a diagram illustrating simulated signal and artificial noise beams in a free-space-optical (FSO) link, according to an exemplary embodiment.

FIG. 4 is a diagram illustrating simulated and measured intensity profiles of artificial noise and signal beams, according to an exemplary embodiment.

FIG. 5 is a diagram illustrating simulated and measured intensity profiles of artificial noise and signal beams, according to an exemplary embodiment.

FIG. 6 is a depiction of signal-to-artificial-noise ratios at protected and receiver positions, according to an exemplary embodiment.

FIG. 7 is a diagram showing an on-axis intensity distribution of an artificial noise beam and an on-axis signal-to-artificial-noise ratio distribution, according to an exemplary embodiment.

FIG. 8 is a depiction of signal-to-artificial-noise ratios at protected and receiver positions, according to another exemplary embodiment.

FIG. 9 is a diagram of a spatial profile of signal, artificial noise, and Gaussian noise beams at a protected position, according to an exemplary embodiment.

FIG. 10 is a diagram of a spatial profile of signal, artificial noise, and Gaussian noise beams at a receiver position, according to an exemplary embodiment.

FIG. 11 is a diagram showing interference between Bessel beams with different longitudinal wave numbers, according to an exemplary embodiment.

FIG. 12 is a diagram showing interference between Bessel beams with different longitudinal wave numbers, according to an exemplary embodiment.

FIG. 13 is a flow diagram of a method for enhancing physical layer security using artificial noise, according to an exemplary embodiment.

FIG. 14A is a block diagram depicting an implementation of a network environment including a client device in communication with a server device, according to an exemplary embodiment.

FIG. 14B is a block diagram depicting a cloud computing environment including a client device in communication with cloud servers, according to an exemplary embodiment.

FIG. 14C is a block diagram depicting an implementation of a computing device that can be used in connection with the system depicted in FIG. 1, according to an exemplary embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

The embodiments disclosed herein can utilize any wireless directional links, for example, Free-space optical (FSO) communication links. While FSO communication links are used as examples of wireless directional links throughout the application, it should be understood that the present disclosure can utilize any wireless directional links and electromagnetic frequency ranges. For example, reference may be made throughout to “optical” wireless links, but it should be understood that the systems and methods described herein may be applicable to wireless links associated with any portion or range of the electromagnetic spectrum.

The wireless directional links (e.g., the FSO links) may possess an ability for high transmission capacity. The transmission medium of systems utilizing wireless communication links may be “unguarded” (e.g., unsecure or unprotected). Unguarded systems may lack an ability to protect the data channel against eavesdroppers. Physical layer security (PLS) systems in which the physical system is made more difficult to eavesdrop while still being compatible with existing security technologies may be a useful remedy for FSO systems. In various wireless applications, a physical layer security approach may include creating a scenario in which the data signal is “buried” in the channel artificial noise, such that an eavesdropper or snooper without a proper receiver might be unable to recover the data. The PLS of wireless directional link may be enhanced by co-propagating an additional artificial noise channel that is tailored to have a lower energy density only near the location of an intended receiver. This system overcomes a reliance on snoopers being located at a distance sufficiently far from the transmitter or sufficiently off-axis such that the snoopers receive insufficient signal power for decoding to achieve utilization in situations in which a location of a snooper is unknown. Additionally, this system overcomes the drawbacks of approaches using generation of larger artificial noise at known locations of snoopers, specifically the inefficiency of these approaches, when the location of a snooper is unknown.

In various embodiments, the system may include a plurality of waves, beams, or channels. A first beam or channel contain a signal carrying data to a receiver. A second beam or channel may transmit artificial noise. The signal and artificial noise channels may have the same wavelength. At any or all locations of an eavesdropper or snooper located outside of a defined region, a signal-to-artificial-noise ratio may be low, preventing the snooper from determining the data transmitted in the signal channel. At the receiver, the signal-to-artificial-noise ratio may be high, allowing the receiver to receive the data without also receiving noise from the artificial noise channel.

The system may be implemented, for example, by utilizing a plurality of lasers to generate the optical beams. Each beam may pass through a polarization controller to modify a polarization state of each beam. Each beam may then pass through an I/Q modulator coupled to an arbitrary waveform generator to modulate each beam. An erbium-doped fiber amplifier may be used to amplify the modulated beam. The beam may then pass through a second polarization controller to a collimator to narrow the beam. The collimated beam may be reflected off of one or more mirrors to a spatial light modulator. The beam may travel a variable propagation length and pass through a final collimator, EDFA, and polarization controller before being received at a coherent receiver.

One or more additional artificial noise channels may be incorporated into the system. The additional artificial noise channel may be a Gaussian beam carrying noise. The additional channel may decrease a signal-to-artificial-noise ratio at one or more locations where the ratio of signal power to the artificial noise power contained in the first artificial noise beam is above a certain desired value. Having too high of a signal-to-artificial-noise ratio may enable a snooper to more easily detect the signal.

Further, existing physical-layer security techniques for directional wireless links may generally rely on steering, focusing, or otherwise concentrating the desired signal in a selected direction. However, such approaches may fail to prevent interception by an unauthorized receiver located along that same direction, particularly when the unauthorized receiver is positioned closer to the transmitter than the intended receiver. In such cases, the eavesdropper may still observe sufficient signal quality to detect, demodulate, or decode the transmitted information, even though the beam is directionally confined.

Various systems and methods may address this technical challenge by transmitting, together with the desired signal beam, an artificial-noise beam that may be structured along the propagation axis. In some embodiments, the artificial-noise beam may be configured so that, over substantially the entire propagation path, the artificial noise has sufficient power relative to the desired signal to keep the signal-to-artificial noise ratio below a threshold for unauthorized reception. The artificial-noise beam may be further configured to have a localized longitudinal dip or reduced-intensity region at the position of the intended receiver, such that the intended receiver may experience a sufficiently high signal-to-artificial noise ratio for successful data recovery while locations outside that region remain protected.

In some implementations, generating such a longitudinally varying artificial-noise beam may be achieved by synthesizing a selected longitudinal wavenumber spectrum, for example through superposition of multiple modes having different longitudinal wavenumbers. This may allow the artificial-noise beam to maintain strong masking over most of the link while exhibiting a controlled reduction in noise power at the intended receiver location. As a result, various systems and methods may provide distance-selective physical-layer security along a line-of-sight path, including against eavesdroppers positioned on-axis between the transmitter and the legitimate receiver.

This disclosure relates to enhanced PLS in an FSO link by longitudinally tailoring noise power to overwhelm signal power. An additional channel may be propagated along with the signal beam. The additional channel may be any signal that does not carry useful information (e.g., a message, etc.) and has an appropriate signal to mask a desired signal (e.g., the signal beam). In some embodiments, the additional channel may be an additive white Gaussian noise (AWGN) signal. Transverse profiles of the beams may be tailored along a longitudinal direction using, e.g., a combination of Bessel modes with different longitudinal wavenumbers. An artificial noise channel may have a larger beam profile and lower central power at a distance where the designated receiver is located. A signal-to-artificial-noise ratio (SANR) difference may be of varying values depending upon whether the artificial noise is “on” or “off” For example, at one or more locations, an SANR difference may be measured to be 20 dB. The system described herein may be utilized in situations where a location of one or more snoopers is unknown.

According to various implementations, the systems and methods described herein may be applicable to fixed wireless or otherwise substantially line-of-sight communication links in which the intended transmitter-to-receiver distance is known or can be estimated. For example, the systems and methods may be applicable to satellite communications, free-space optical communication, in particular when services such as high-speed or time-sensitive trading (e.g., stock trading or other processes that may not be able to use complicated cryptographic processes), military operations, and the like, operate over them. Further, in various embodiments, various systems may be used in applications in which a distance between a transmitter and an intended receiver is not fixed, but varies over time. So long as the link remains substantially line-of-sight and the transmitter has knowledge of, or can estimate, the intended receiver distance, the beam-design parameters may be adjusted to move the receiver region or security zone to the desired location. For example, the longitudinal wavenumber spectrum, modal coefficients, and/or other beam-structuring parameters may be updated dynamically so that the reduced-noise region tracks the changing receiver position. In this manner, the system may provide distance-selective physical-layer security even for links with time-varying but known or measurable separation between the transmitter and receiver.

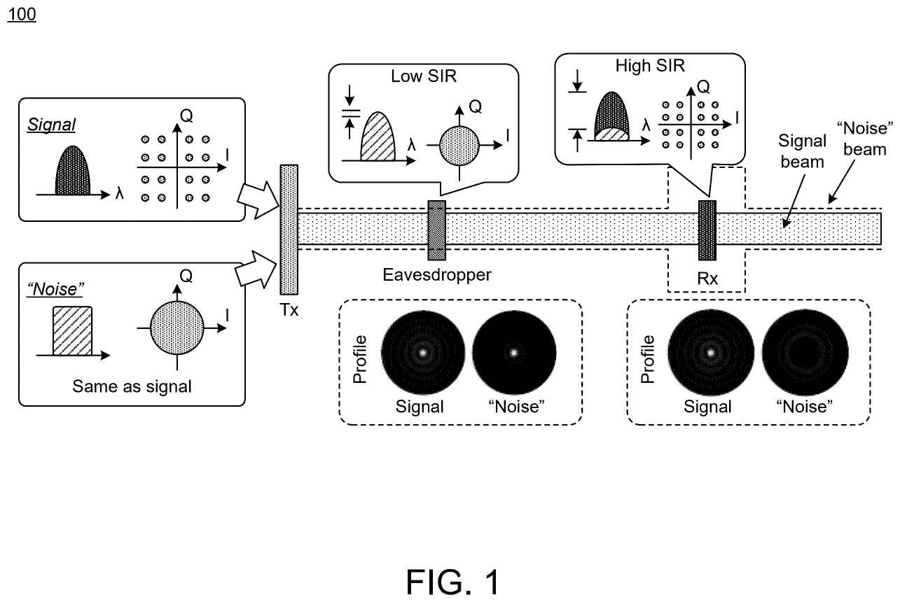

Referring now to FIG. 1, a diagram 100 illustrating PLS enhancement is shown, according to an example embodiment. The PLS system may be enhanced by longitudinally adjusting a noise power to overwhelm a signal power. On a signal channel, the desired signal may be propagating along an axis, such as an axis of propagation between a transmitter and a receiver. An additional channel may be modulated with artificial noise, which may have truly random, pseudo-random, or chaotic properties, and can obey various amplitude statistics and temporal correlations, and co-propagated with the signal channel (e.g., the artificial noise channel may be propagated along the same axis as the desired signal). A transverse profile of the artificial noise may be tailored along the longitudinal direction. The transverse profile may be designed to have a wider profile with a lower central power at one or more specific propagation distances.

To enhance the security of optical (or other) wireless links, the artificial noise channel may be propagated together with the signal channel (e.g., the artificial noise channel may be propagated along the same axis or a similar axis as the signal channel). A beam profile of the artificial noise may be modified longitudinally by approaches of structured light. The artificial noise channel may also be designed to have the same optical spectrum as the signal. As a result, the artificial noise beam may overlap with the signal beam at most distances, and the eavesdropper may receive both signal and artificial noise with low SANR at incorrect longitudinal locations. The artificial noise may enforce a minimum or reduced SANR at any distance, both along the axis and offset from the axis. The interference between two channels may protect the signal from being snooped. For example, when a SANR is below a certain threshold value, it may be difficult or physically impossible for a snooper or eavesdropper (or other party) to decode information. When the SANR is above the threshold value, the information may be able to be decoded. As such, a snooper may be unable to obtain observations with an SANR that is sufficient to decode the signal. At a propagation distance where the intended receiver is located, the artificial noise beam can present a larger beam profile with lower central power. Therefore, the receiver can achieve high SANR and detect the correct signal. Thus, in an area along the axis around the receiver location or a desired receiver location, the artificial noise may have a lower intensity such that the receiver can perform decoding of the signal. That is, at the location of an intended receiver, a SANR may be above a threshold value, and at all other locations (e.g., locations where an eavesdropper may be positioned), the SANR may be below the threshold value. This may establish a physically secure communication link between transmitter and receiver.

The systems and methods described herein may tailor AN power received by an eavesdropper and legitimate receiver at different longitudinal locations. To tailor the AN, a transverse profile of the AN beam may evolve along a longitudinal distance. At various distances, the transverse electric field amplitudes of the AN beam |EAN| and signal beam |Es| may need to be similar. Therefore, spatial overlap between the AN and signal beams may be maximized to enhance SNR protection. At the vicinity of the legitimate receiver (“receiver region”), the AN beam may transversely expand and lower its amplitude. As a result, the legitimate receiver can capture the signal with less noise. Over the transverse plane, the ideal requirements can be expressed as:

$$\{ \begin{matrix}\vert EAN ( r , θ , z ) \vert \approx \vert Es ( r , θ , z ) \vert , z / ∈ [ z 1 , z 2 ] , ∀ r , θ , \\ \{ \vert EAN ( r , θ , z ) \vert << \vert Es ( r , θ , z ) \vert , z ∈ [ z 1 , z 2 ] , r \leq R , ∀ θ\end{matrix}$$

where (r, θ, z) denotes the cylindrical coordinates, [z1, z2] is the receiver region, and R is the radius of the main lobe of the signal beam.

In one implementation, such beam shaping can be achieved by using a series of fundamental zero-order Bessel modes with equal-spaced longitudinal wavenumbers, and the transverse electrical field

$$E = {Σ}_{n} {C}_{n} \cdot {J}_{0} ( {k}_{{r}_{n}} r ) {e}^{i ( {k}_{{z}_{n} z} - ω t )} .$$

ω may be the angular frequency,

$${k}_{{z}_{n}}$$

may be the longitudinal wavenumber with an equal-spacing Δk_{z},

$${k}_{{r}_{n}}$$

may be the transverse wavenumbers associated with ω and k_{z}_{ₙ}, and Cₙ may be a complex weight of the Bessel mode. The electric field of a Bessel beam may be represented as E_{Bassel} (r, θ, z; t)=J₀ (rkᵣ) eⁱ(^{kzz-ωt) where t denotes the time; ω is the angular frequency; kz is the longitudinal wavenumber; kr is the transverse wavenumbers associated with kz, obeying that}

$${k}^{2} = {k}_{z}^{2} + {k}_{r}^{2} ,$$

and k is the wavenumber given by k=ω/c, where c is the speed of light. J₀(·) is the zeroth-order Bessel function of the first kind.

The use of Bessel modes or Bessel beams may implement the artificial noise as a “structured light” signal. In various embodiments, the temporal pulse shape can be crafted by manipulating the frequency spectrum. Similarly, the longitudinal response of the transverse field can be governed through the control of longitudinal wavenumbers. Required complex weights Cₙ can be computed through a Fourier transform of the longitudinal waveform

$$f ( z ) = \{ \begin{matrix}0 , z = receiver location \\ 1 , elsewhere\end{matrix} .$$

Therefore, the artificial noise beam may exhibit lower central intensity near the receiver, and the artificial noise power may be distributed outside the central beam due to destructive interference.

Such a proposed system can be demonstrated for wireless communication systems in multiple frequency bands, including but not limited to infrared light, millimeter wave, and sub-terahertz. Generally, a PLS communication system will require two frequency sources for the signal and artificial noise beam. The signal beam path will directly modulate the source with the signal sequence. The noise may be generated from artificial noise sequences, or the thermal noise of resistors, or other natural or artificial noise sources. The artificial noise can be generated in a way to produce certain desired spectral properties, e.g., to be similar to the spectrum of the desired signal, or to be flat over the bandwidth of interest. Subsequently, the transverse fields of the signal and artificial noise beams may be tailored by spatial modulation. Spatial modulation techniques include spatial light modulators, phase plates, meta surfaces, etc. A receiver may be placed at different locations within a predetermined propagation distance to measure the received signal. Using one or more longitudinal wavenumbers, the artificial noise channel may be “turned off” at a specific propagation distance. Overall, the artificial noise beam may be designed to result in the signal-to-artificial-noise ratio being above a desired threshold in a certain region, where the size of the region can be designed by shaping the beams, while it is below a certain threshold outside this region. The beam may be designed in such a way that the properties of the SANR are fulfilled not only when averaged over the cross section of the transmit beam, but also for (potentially arbitrary) subregions of this beam. In this manner, a size of the region surrounding a location of the receiver within which the signal may be decoded may be designed. For example, the size of the region may be determined by a field design of the artificial noise. In various embodiments, a Fourier series expansion may describe a tradeoff between, for example, a number of spatial modes, signal amplitudes, and a difference in the signal-to-artificial-noise value inside and outside of the region.

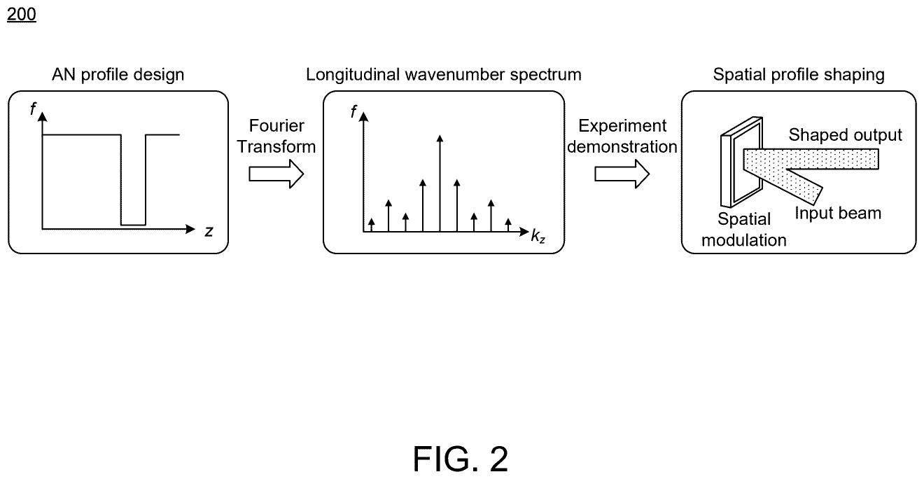

FIG. 2 shows a block diagram 200 of the PLS system, according to an example embodiment. As discussed above, the intensity of an artificial noise beam may be longitudinally dependent (e.g., intensity of the artificial noise may depend on a longitudinal position along a propagation axis). FIG. 2 shows the relationship between an artificial noise profile design, a longitudinal wavenumber spectrum, and a spatial profile shaping. A longitudinal dependence of the on-axis intensity of the artificial noise beam may be realized by synthesizing a longitudinal wavenumber spectrum according to the Fourier series. For example, a Fourier transform of an artificial noise signal may be taken to generate a longitudinal wavenumber spectrum (e.g., an indication of a wavenumber of the artificial noise signal at different longitudinal locations). A composite, superposition of beams (e.g., Bessel beams) based on the longitudinal wavenumbers may present a designed longitudinal behavior at a center lobe.

Analogous to the Fourier relationship between a temporal pulse and its frequency spectrum (i.e., e^{-iωt}), the intensity profile of the transverse field along the propagation distance may be designed through the control of longitudinal wavenumbers (i.e., e^{-kzz}). As such, the AN beam can be constructed by the propagation-dependent interference between a series of Bessel beams with equally-spaced k_{z} values k_{z,m}=k_{z,0}+2πm/L, (—M≤m≤M), where m is the longitudinal wavenumber index and the total number is 2M+1; k_{z,0} is the center longitudinal wavenumber; L is the total propagation distance of the longitudinal design, and 27 cm L determines the longitudinal wavenumber spacing. Given a specific longitudinal structure, the complex coefficients of Bessel beams with different kz values can be calculated by the Fourier series. Specifically, for the receiver region, different Bessel modal components may experience destructive interference at the center of the beam, and the beam power may be redistributed from the center of the beam to the outside lobes. Therefore, the AN beam may exhibit lower central intensity and the side lobes may experience higher power. Further, the intensity evolution of a longitudinally structured beam composed of Bessel beams may be periodic along the propagation direction, which may be analogous to a periodic signal generated by a Fourier transform. However, in practice, Bessel-Gaussian beams may be used to construct an AN beam. Such Bessel-Gaussian beams may diverge rapidly beyond a Rayleigh range (i.e., the maximum propagation distance of the design). Additional information, such as about natural noise (e.g., environmental noise) may be used to ensure a total amount of noise (e.g., a combination of artificial noise, thermal noise, environmental noise, etc.) is below a threshold value to allow for decoding of the signal/message by the intended receiver.

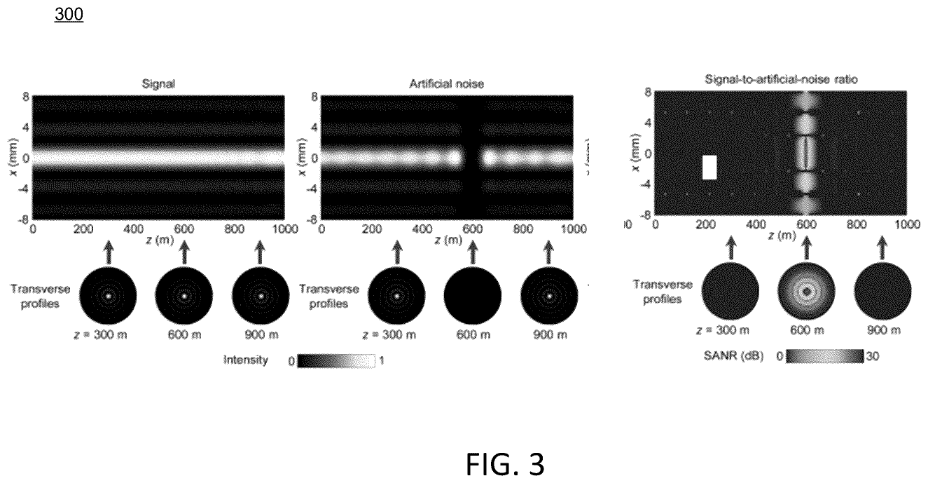

FIG. 3 shows a diagram 300 illustrating simulated signal and artificial noise beams in a free-space-optical (FSO) link, according to an exemplary embodiment. As shown, a signal beam may remain consistent or relatively consistent (e.g., in intensity) along a propagation axis. For example, at various locations along a z direction (e.g., a longitudinal direction, along the propagation axis, etc.), a transverse profile of the signal beam may be the same or substantially the same. Conversely, an artificial noise beam may remain consistent or relatively consistent (e.g., in intensity) along the propagation axis except at a location where the receiver is positioned. To create a spectrum for a beam, the superposition of different modes with different wavenumbers may be required in order to create the spectrum or to create a power structure with a gap (e.g., a lower amount of power) at a location of a desired receiver.

In the example shown in FIG. 3, the receiver is located at approximately z=600 m. As such, signal and artificial noise beams may overlap at positions along the propagation axis such that the signal may be undetectable except at the location of the receiver. As shown, at z=300 and z=900, a transverse profile of the artificial noise beam may be the same or similar, but at z=600, the intensity of the artificial noise beam may be zero or close to zero. As such, at z=600, only the signal beam is present, allowing the receiver to receive the desired signal while protecting the signal from snoopers located at positions other than a position of the receiver.

As further shown in FIG. 3, a signal-to-artificial-noise ratio (SANR) may be low at all points along the propagation axis except at the location of the receiver, z=600 m. A signal-to-artificial-noise ratio (SANR) may be the ratio of the signal beam intensity to the AN beam intensity at a specific location (e.g., SANR=I_{signal}/I_{AN}). This SANR value may not consider system noise at the receiver (e.g., thermal noise, shot noise, Flicker noise, etc.). The SANR value along the propagation direction is shown in FIG. 3 when the signal and AN beams are transmitted with the same power. As shown, the x-z SANR distribution features a high SANR zone near z=600 m, while almost everywhere outside the designed receiver region may have a sufficiently low SANR (i.e., close to or lower than 0 dB). The on-axis SANR shows, as an example, a maximum value of 26.4 dB at z=600 m, and the region where SANR is >10 dB has a range of 44 m. This may indicate that, at all points other than z=600 m, a signal level and an artificial noise level may be the same or similar. However, at the position of the receiver, the SANR may be greater (e.g., above a threshold value, etc.), indicating that the signal may be received without interference from artificial noise.

Further, at a location of the intended receiver, the SANR being above a threshold value may occur at both a center of the beam and at one or more sidelobes of the beam such that, at a longitudinal position of the receiver, a snooper may be unable to decode the signal even if the snooper is located off-center relative to the receiver. For example, a snooper may be positioned off the axis along which the signal propagates, and may experience a better SANR there than along the axis, potentially enabling it to capture the desired signal. As will be described in greater detail herein, an additional artificial noise beam, which may be hollow in the middle, may be propagated along the same axis. This may “drown out” any signal at off-axis locations at a longitudinal position of the intended receiver.

A security zone (e.g., a region within which the desired receiver is located and a SANR above a threshold value is obtained) may be configurable due to the configuration of the beams, as discussed above. For example, the system may be unable to eliminate eavesdroppers but may be able to configure a size of the security zone based on parameters such as application and physical constraints. For example, the region may be made small to limit where successful reception can occur, or larger to allow greater positional tolerance for the intended receiver. The size of the region may also trade off against system parameters such as an achievable signal-to-artificial-noise ratio and the number of modes or longitudinal wavenumbers used to synthesize the artificial-noise beam.

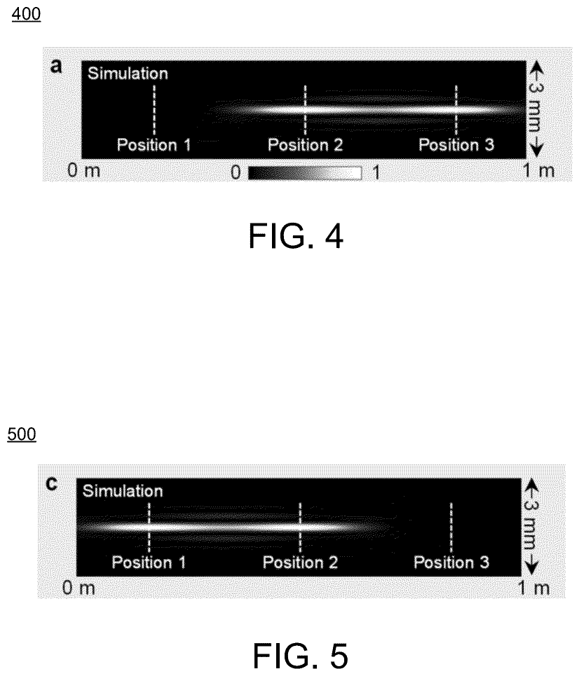

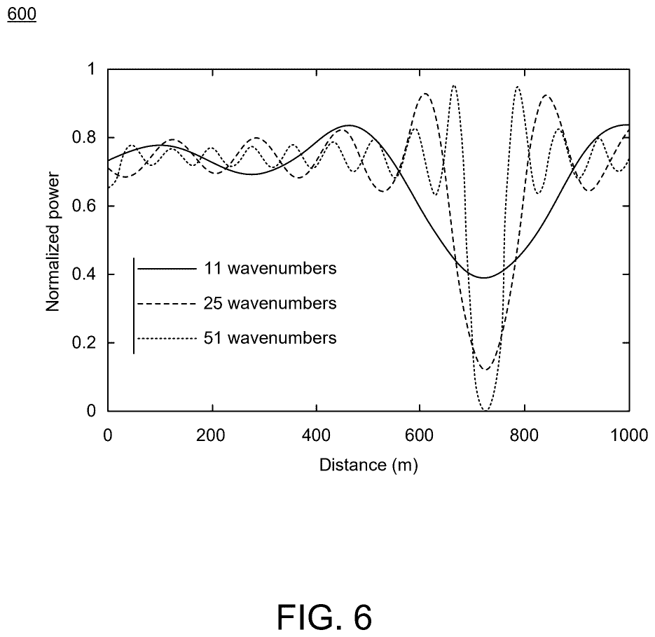

Referring now to FIGS. 4 and 5, various intensity profiles are shown, according to example embodiments. Specifically referring now to FIG. 4, an intensity profile 400 is shown, according to an example embodiment. As shown in FIG. 4, a receiver may be located at position 1, as indicated by a decreased intensity of artificial noise at position 1 compared to positions 2 and 3. In this manner, a SANR may be greater (e.g., above a threshold value) at position 1 and a surrounding region and may be below a threshold value at positions 2 and 3 and surrounding regions. This may allow a signal or message to be decoded by an intended receiver at position 1 (e.g., on the propagation axis or off-center from the propagation axis but within a region of position 1).

Similarly, FIG. 5 shows an intensity profile 500, according to an example embodiment. As shown in FIG. 5, a receiver may be located at position 3. A SANR may be greater at position 3 and a surrounding region and may be below a threshold value at positions 1 and 2 and surrounding regions. This may allow a signal or message to be decoded by an intended receiver at position 3 (e.g., on the propagation axis or off-center from the propagation axis but within a region of position 3). In various embodiments, employing an increasing number of longitudinal wavenumbers for beam synthesis may result in a narrower “noise off” region for the receiver. This may be similar to the concept of additional temporal frequencies enabling more precise pulse shaping. As such, a greater number of longitudinal wavenumbers may reduce a size of the region surrounding a position of an intended receiver within which a signal may be received and decoded.

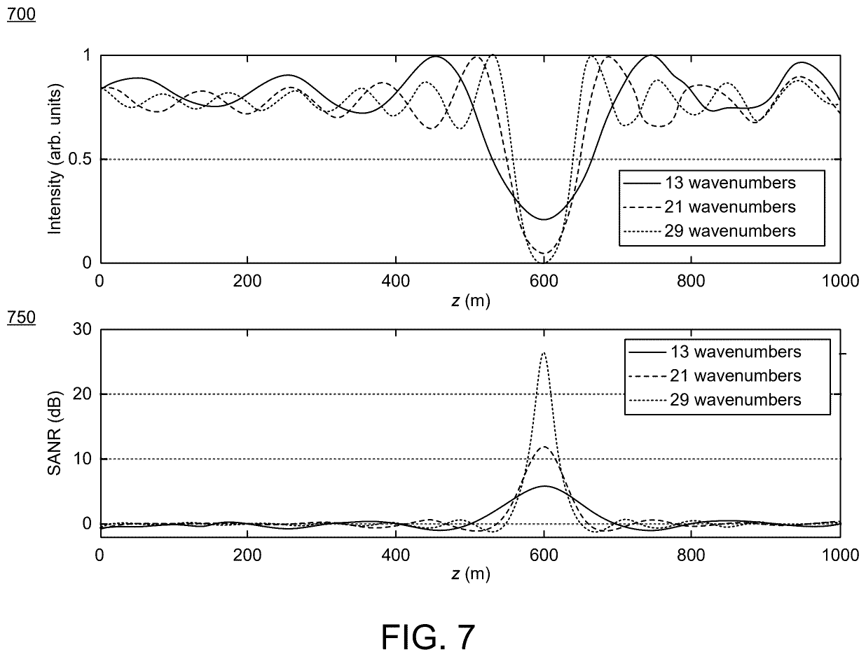

Referring now to FIGS. 6-8, an extension of the system described herein is described, according to an example embodiment. In various embodiments, one or more additional beams carrying artificial noise may be included in the security enhancement scheme described above. The one or more additional beams may be, for example, Gaussian beams. As described above, the artificial noise and signal beams may be made of a series of Bessel beams and may co-propagate. Further, the spatial profiles of the artificial noise and signal beams may generally overlap during security-enhanced protected regions. However, there may be imperfect overlapping between sidelobes of the beams, which can degrade SANR protection. Additionally, at various locations, the signal beam may have a stronger signal than the noise while still being weaker than the signal strength at the beam center. These locations may be, for example, off-axis. An additional beam that can create a SANR having a value below a threshold value at any off-axis location may be added to the system. A SANR value being below a threshold value may correspond to a SANR that is insufficient to allow for decoding of the message (e.g., first signal). In this manner, a SANR below a threshold value may provide a finite or positive secure data rate. The additional beam may have a different beam shape than the signal beam or the existing artificial noise beam. For example, the additional beam may be a Gaussian beam. The additional beam may reduce an on-axis SANR. Selecting specific amplitudes of the additional beam may allow the transmitter to continue to transmit a signal (or allow the receiver to continue to receive a signal) while allowing an insufficient SANR at any location in space outside of the region around the receiver.

In some implementations, sidelobes of one or more transmitted beams may be utilized to improve physical-layer security rather than being treated solely as an undesirable artifact. For example, a first artificial-noise beam may be longitudinally structured to produce reduced noise power in a receiver region while substantially overlapping a desired signal beam in one or more protected regions. However, if the first artificial-noise beam does not sufficiently cover sidelobes of the desired signal beam, those sidelobes may create localized regions outside the intended receiver region in which the signal-to-noise ratio (SNR), signal-to-interference ratio (SIR), or signal-to-artificial-noise ratio (SANR) is higher than desired. Such localized regions may potentially be exploited by an eavesdropper.

To reduce or eliminate such leakage regions, an additional artificial-noise beam may be transmitted with the signal beam and the first artificial-noise beam. The additional artificial-noise beam may be configured as a broader beam, such as a Gaussian-like beam or other beam having a wider transverse extent, such that the additional artificial-noise beam may overlap transverse sidelobe regions of the desired signal beam and/or of the first artificial-noise beam. Because sidelobes generally may have lower intensity than a main lobe, the additional artificial-noise beam may have lower power than would be required to mask the main lobe while still being sufficient to reduce the SNR in the sidelobe regions below a detection or decoding threshold. In this way, the additional artificial-noise beam may provide supplemental protection in off-axis regions and other regions not fully protected by the first artificial-noise beam.

In some embodiments, the additional artificial-noise beam may not exhibit the same degree of spatial precision as the first artificial-noise beam. For example, the additional artificial-noise beam may be configured without a sharply defined longitudinal null at the receiver location, and instead may provide a comparatively broad background-noise distribution that covers transverse regions outside a central receiver aperture. Although this additional artificial-noise beam may reduce the SNR at the intended receiver, the received SNR at the intended receiver may remain above a decoding threshold while the SNR at unintended observation locations, including sidelobe regions, may remain below the decoding threshold. Accordingly, the introduction of the additional artificial-noise beam may improve overall security by sacrificing only a limited amount of receiver margin, data rate, and/or link budget.

Referring now to FIG. 6, a graph 600 showing an SANR value across the transverse profile is shown, according to an example embodiment. At a location in the protected region, the SANR at the center lobe may be low. This may protect the signal beam from the eavesdropper. Further, at the protected region, there may be a plurality of sidelobe rings where the SANR value is greater than a specific value (e.g., 3 dB), which may degrade system security and potentially allow the eavesdropper to detect the signal.

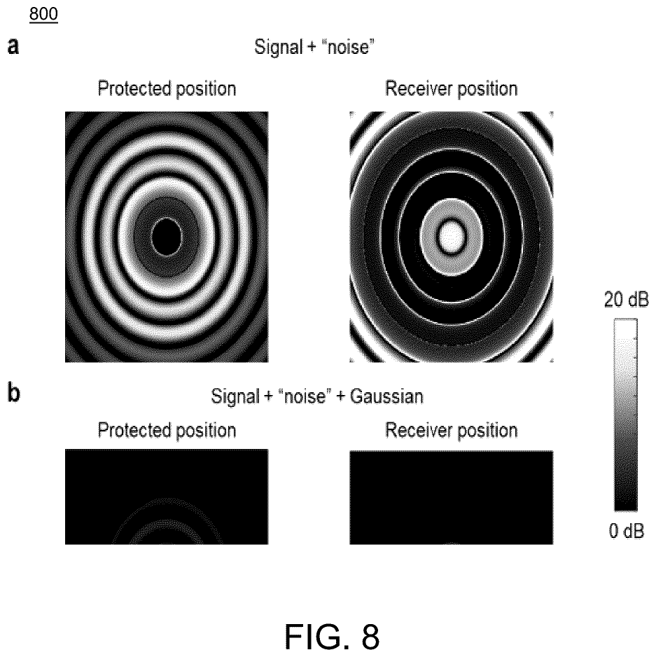

Referring now to FIG. 7, an on-axis intensity distribution 700 of the AN beam using different numbers of wavenumbers is shown, according to an example embodiment. An on-axis SANR distribution 750 using different numbers of wavenumbers is also shown, according to an example embodiment. That is, FIG. 7 depicts an on-axis distributions of the AN intensity and SANR using different numbers of k_{z} (e.g., different numbers of wavenumbers). A larger number of k_{z} components may bring improved fitting of on-axis distributions because more frequency components may be utilized to reconstruct the waveform. A relationship between a maximum on-axis SANR and a length of a receiver region may increase under increasing k_{z} numbers. For example, as a number of wavenumbers increases, a maximum SANR may increase as a size of the security zone increases. For example, using 29 wavenumbers, the maximum SANRs are 26.4, 8.9, and 2.3 dB when a length of the receiver region is 50, 30, and 10 m, respectively. For fewer wave numbers, maximum SANRs may be decreased at each length of the receiver region. Generally, a narrower receiver region may lead to reduced SANR, as a narrower waveform may incorporate more high-frequency components.

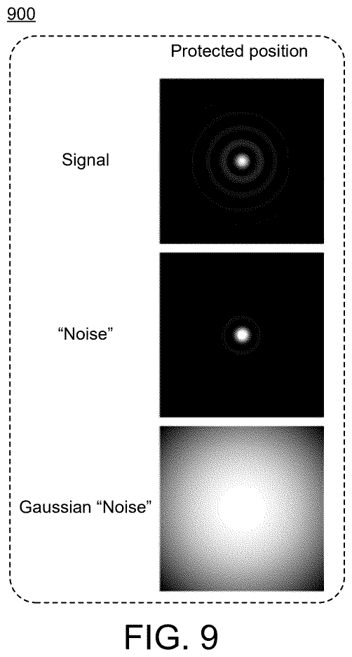

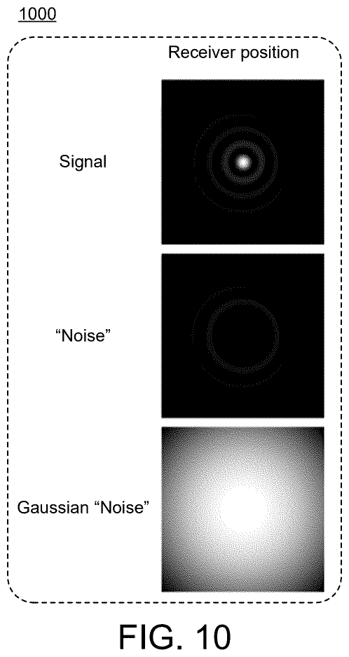

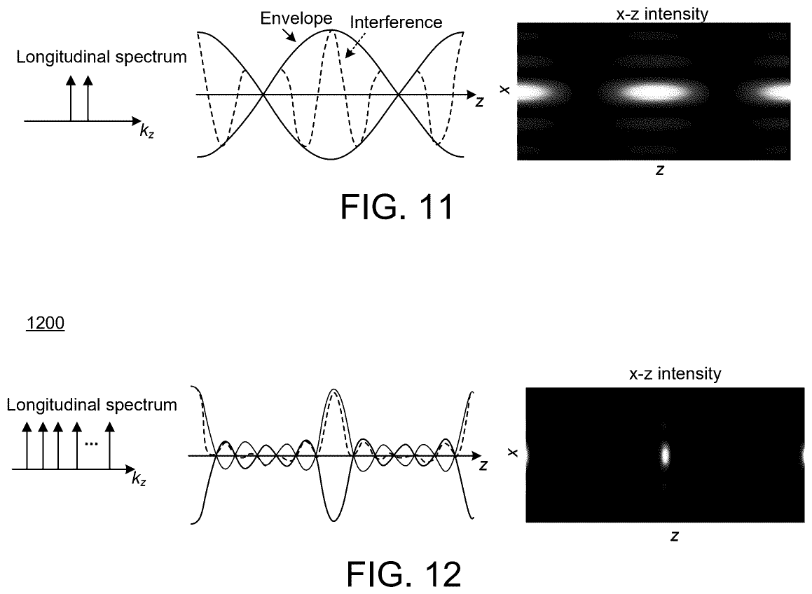

One or more additional artificial noise beams may be added to the system described with reference to FIGS. 1-3. Referring now to FIG. 8, a graph 800 showing an SANR ratio at the protected and receiver position is shown, according to an example embodiment. Specifically, one additional artificial noise beam may be added to the system. Generally, in various embodiments, Bessel modes may be used to construct the AN and signal beams. Side lobes of Bessel modes may, in some embodiments, degrade SNR protection across a transverse plane in the receiver and protected regions, which may result in potential attack risk. To mitigate an attack risk, an additional (e.g., second) AN beam may be included or propagated along the propagation axis as a general noise background. The second (e.g., one additional) artificial noise beam may have a large Gaussian profile. The second artificial noise beam may cause a weak background noise to be added that may decrease the SANR of sidelobes. In various embodiments, the sidelobes may have weaker intensities compared to the center lobe. Thus, the noise from the second artificial noise beam may effectively protect the signal on sidelobes. As shown in FIG. 8, the maximum SANR is less than the maximum SANR of FIG. 6. Specifically, in FIG. 8, the maximum SANR may be less than 3 dB at the protected position. At the receiver position, the low-intensity Gaussian beam may not affect the receiver SANR. Spatial profiles 900 and 1000 of the signal, artificial noise, and Gaussian noise beams at the protected and receiver positions are shown in FIGS. 9 and 10, respectively.

The snooper may be prevented from determining the spatial structure of the artificial noise (AN) (e.g., the additional noise beam), which could then be used to eliminate the AN. To prevent the determination of the spatial structure of the AN to eliminate the AN, the spatial structure of the AN may be randomized. While the spatial structure may be randomized, the SANR may still stay below a threshold at all observation points. This can be achieved by changing transmission parameters for each mode of the AN beam, as well as relative amplitudes of the different modes making up the AN beam. Further, the desired signal can be spatially modulated, including transmitting the desired beam as a combination of different modes whose amplitudes can be varied compared to each other.

Further, in some embodiments, an AN field may be configured to hide the desired signal in multiple dimensions in addition to longitudinal position. For example, the AN may overlap the signal in bandwidth, polarization, and/or spatial mode. In this way, the signal may be obscured in both the physical space as well as spectral, polarization, and/or modal domains, thereby making unauthorized recovery of the signal more difficult.

In some implementations, the AN may have a bandwidth equal to or greater than that of the desired signal such that the signal may be spectrally buried within the AN. The AN may also occupy one or more polarization states, including the same polarization as the desired signal, an orthogonal polarization, or both. These additional degrees of freedom may make it more difficult for an eavesdropper to isolate the signal using filtering or polarization-selective reception.

Further, in some embodiments, the AN may be distributed among multiple spatial modes. This may be beneficial where a snooper has access to multiple observation points and may attempt to reconstruct the spatial structure of the AN and separate it from the desired signal. If the desired signal has a simple or known spatial structure while the AN has a different and identifiable structure, such separation may be easier. To reduce this risk, the AN may occupy multiple spatial modes, and the desired signal may also be transmitted in multiple modes or otherwise lack a fixed, easily identifiable spatial structure. Accordingly, by extending the AN across multiple dimensions and, in some cases, also reducing the predictability of the desired signal structure, the system may provide improved resistance to interception and signal-separation attacks.

Additionally, to protect signals, beam profile hopping may be implemented. The spatial profiles of the desired signal beam and the artificial-noise (AN) beam may not be kept fixed over time. Instead, parameters used to synthesize the structured beams may be varied in the temporal domain in a manner analogous to frequency hopping. For example, the longitudinal wavenumbers, center longitudinal wavenumber, wavenumber spacing, modal amplitudes, modal phases, and/or other expansion coefficients used to generate the desired signal beam and the AN beam may be changed over time, including in a random, pseudo-random, or otherwise time-varying manner.

In some implementations, the time-varying changes may be selected such that the overall functional behavior of the beams may remain substantially the same from the standpoint of the intended receiver. For example, the AN beam may continue to exhibit a reduced-intensity region or null at or near the intended receiver location, while maintaining higher overlap with the desired signal outside the receiver region. Although the exact modal composition, spatial intensity distribution, and spatial phase distribution may vary over time, the receiver may still experience sufficient signal quality for data recovery. As such, the system may preserve the intended protected zone while changing the specific beam structure used to create that zone.

This time variation may improve security by making it more difficult for a snooper to determine or exploit the spatial structure of the beams. For example, an unauthorized receiver may attempt to observe the field at one or more locations in order to infer the modal structure of the desired signal beam and the AN beam, and then use that inferred structure to separate the desired signal from the AN. By the time such a structure is estimated, however, the transmitter may already have changed the relevant wavenumbers, amplitudes, phases, or other modal coefficients. As a result, the unauthorized receiver may be forced to repeatedly restart the estimation process, thereby reducing the likelihood of successful interception.

Accordingly, in some embodiments, multiple different beam configurations may be used to generate substantially the same receiver-region behavior, such as a broad null or reduced-noise region near the intended receiver. By hopping among these different configurations over time, the system may maintain decodability at the intended receiver while increasing resistance to spatial reconstruction, modal decomposition, and signal-separation attacks.

Finally, to protect signal beams, spatial channel multiplexing may be utilized. In some embodiments, the systems and methods described herein may be compatible with channel multiplexing techniques used to increase communication capacity. For example, the system may be used together with wavelength division multiplexing, polarization division multiplexing, and/or spatial division multiplexing. Although the disclosed systems and methods may utilize spatial beam shaping to control the longitudinal and transverse behavior of the desired signal and artificial-noise (AN) beams, such spatial structuring may not preclude the use of multiple parallel channels.

In some implementations, spatial channel multiplexing may be achieved by transmitting multiple signal beams and corresponding AN beams using different spatial mode orders. For example, the desired signal may be imposed on beams having different orbital angular momentum (OAM) orders or other higher-order spatial modes. Each signal beam may be paired with a corresponding AN beam structured to provide the desired security behavior for that mode, including reduced AN intensity in a receiver region and increased masking outside that region. In this manner, multiple independently modulated channels may be transmitted simultaneously, each associated with a different spatial mode.

In some embodiments, the longitudinal structuring approach, described for zeroth-order Bessel modes, may also be applied to higher-order Bessel modes or other modal families associated with nonzero OAM. The same general principles of longitudinal shaping and transverse overlap may therefore be maintained while using different mode orders as separate communication channels. Thus, multiple signal/AN beam pairs may be co-propagated, with each pair occupying a different spatial mode order and carrying a separate data stream.

The use of spatial multiplexing may further enhance security in addition to increasing data capacity. For example, by transmitting information over multiple spatial mode orders, the overall field structure may become more complex in both the longitudinal direction and across the beam cross-section. The increased spatial complexity may make it more difficult for a snooper to determine the structure of any individual desired signal beam, any corresponding AN beam, or the relationship between them. Accordingly, spatial channel multiplexing may provide both increased throughput and increased resistance to interception or signal-separation attacks.

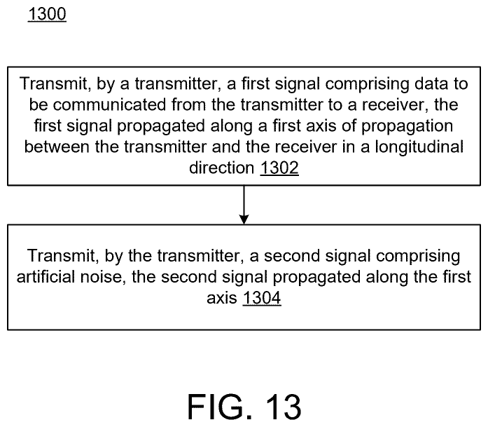

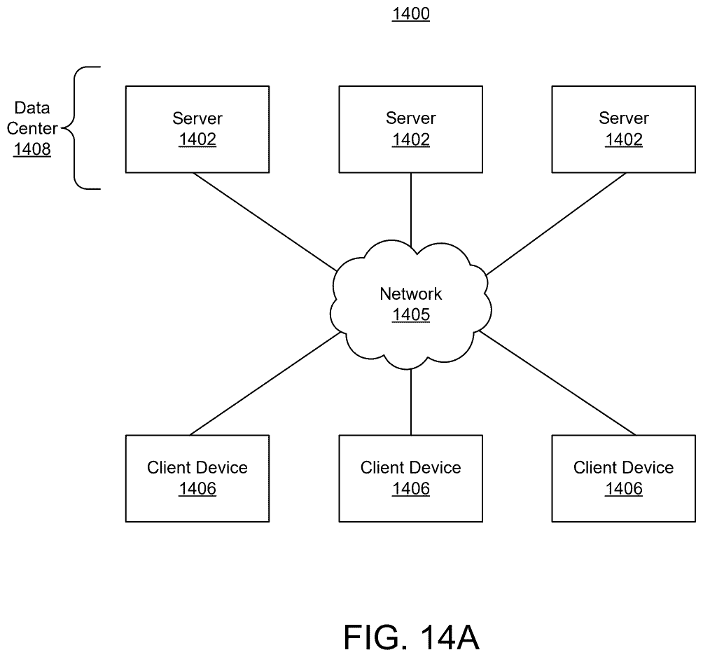

Referring now to FIGS. 11 and 12, graphs showing interference between Bessel beams with different longitudinal wavenumbers are shown, according to example embodiments. Bessel beams with different longitudinal wavenumbers may result in an interference along the propagation distance, thereby enabling longitudinal intensity control along the propagation path.

Referring specifically to FIG. 11, a diagram 1100 shows Bessel beams with two different longitudinal wavenumbers, according to an example embodiment. As shown on the longitudinal wavenumber spectrum, each upward pointing arrow may represent one wavenumber k_{z}. An intensity envelope may show that, with only two wavenumbers, an envelope space may be larger, leading to greater interference. FIG. 11 further shows an intensity profile of the resulting beams. As shown, there may be little to no intensity at points at which the two waves intersect on the z axis.

Referring specifically to FIG. 12, a diagram 1200 shows Bessel beams with rectangular-shaped longitudinal wavenumbers. As shown on the longitudinal wavenumber spectrum, each upward pointing arrow may represent one wavenumber k_{z} and there may be any n number of wavenumbers. An intensity envelope may show that, with a greater number of wavenumbers, an envelope space may be smaller, leading to less interference (or less frequent interference). FIG. 12 further shows an intensity profile of the resulting beams. As shown, there may be little to no intensity at points at which the various waves intersect on the z axis.

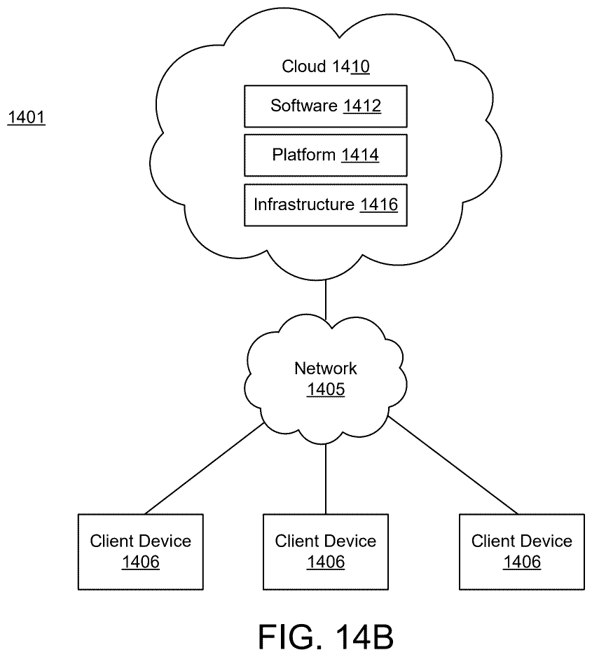

Referring now to FIG. 13, a flow diagram of a method 1300 for enhancing physical layer security using artificial noise is shown, according to an example embodiment.

At process 1302, the method 1300 includes transmitting, by a transmitter, a first signal including data to be communicated from the transmitter to a receiver. The first signal may be propagated along a first axis of propagation between the transmitter and the receiver in a longitudinal direction. In various embodiments, the receiver may receive the first signal.

In some embodiments, the method 1300 includes modulating a spatial profile of the first signal. The spatial profile of the first signal may be modulated by varying one or more of: an amplitude or a transmission parameter of each of a plurality of beams comprising the first signal.

At process 1304, the method 1300 includes transmitting, by the transmitter, a second signal including artificial noise. The second signal may be propagated along the first axis. In some embodiments, the second signal may be propagated along the first axis such that a signal-to-artificial-noise ratio varies along the first axis in a propagation direction to allow the first signal to be decoded within a region surrounding a location of the receiver and prevent the first signal from being decoded at any other location. In various embodiments, the receiver may receive the second signal.

In various embodiments, the second signal may be generated by superposing a plurality of beams. Each of the plurality of beams may have different longitudinal characteristics. In some embodiments, the second signal may include one or more Bessel beams. In some embodiments, each of the one or more Bessel beams may include a different longitudinal wavenumber. That is, the plurality of beams may include a plurality of Bessel beams, and each of the plurality of Bessel beams may include a different longitudinal wavenumber. In some embodiments, the first signal and the second signal are co-propagated along the first axis.

In various embodiments, the second signal may be configured to generate an increased signal-to-artificial-noise ratio within the region surrounding the location of the receiver relative to a signal-to-artificial-noise ratio at other locations along the first axis. The increased signal-to-artificial noise ratio may be generated by generating the second signal from a plurality of Bessel beams. Each of the plurality of Bessel beams may have a longitudinal wavenumber different than a longitudinal wavenumber of the first signal such that a spatial profile of the second signal overlaps a spatial profile of the first signal at all points along the first axis. The signal-to-artificial noise ratio may be greater than a threshold value within the region surrounding the location of the receiver.

The method 1300 may include transmitting a third signal configured to generate an off-axis signal-to-artificial-noise ratio. The off-axis signal-to-artificial noise ratio may have a value less than a threshold value to prevent decoding of the first signal.

In some embodiments, the method 1300 may include randomizing a spatial structure of the second signal. The spatial structure of the second signal may be randomized by modifying one or more transmission parameters of each of a plurality of beams including the second signal and varying a relative amplitude of each of the plurality of beams including the second signal. In some embodiments, randomizing the spatial structure of the second signal may prevent identification of the spatial structure of the second signal.

In various embodiments, the method 1300 may include transmitting a third signal along the propagation axis. The third signal may be configured to generate noise background to decrease a signal-to-artificial-noise ratio of one or more sidelobes to the side of the propagation axis. The third signal may decrease a signal-to-artificial-noise ratio of one or more sidelobes at various locations along the propagation axis (e.g., not just at a location of the intended receiver). In various embodiments, the third signal may have a large Gaussian profile (e.g., a Gaussian profile relatively larger than a Gaussian profile of the first or second signal).

In various embodiments, the second signal may include a plurality of dimensions. The plurality of dimensions may include, in various embodiments, the second signal having a frequency bandwidth above a threshold bandwidth, the second signal occupying two or more polarizations, and/or the second signal having a plurality of spatial modes. The method 1300 may further include generating a second signal having a plurality of dimensions (e.g., one or more of those discussed above). In various embodiments, the plurality of dimensions may be covered by the second signal.

In some embodiments, the method 1300 may include randomly modifying one or more expansion coefficients of the first and/or second signals. In some embodiments, the one or more expansion coefficients may be modified in a temporal domain. In various implementations, modifying the one or more expansion coefficients may alter one or more of: spatial intensity or phase.

Further, in various embodiments, the method 1300 may include transmitting the first and second signals with different mode orders by: modifying a Bessel mode of at least one of the first or second signal to a higher orbital angular momentum mode. In various embodiments, the method 1300 may include transmitting a plurality of first signals and a plurality of second signals, where each of the plurality of first signals has a corresponding second signal, and where each first signal and corresponding second signal has a different orbital angular momentum order.

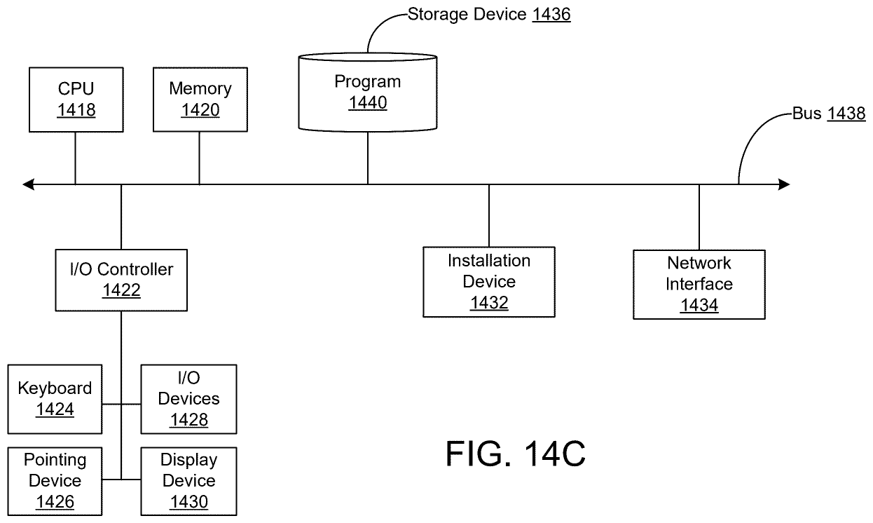

FIG. 14A depicts an example network environment that can be used in connection with the methods and systems described herein. In brief overview, the network environment 1400 includes one or more client devices 1406 (also generally referred to as clients, client node, client machines, client computers, client computing devices, endpoints, or endpoint nodes) in communication with one or more servers 1402 (also generally referred to as servers, nodes, or remote machine) via one or more networks 1405. In some embodiments, a client 1406 has the capacity to function as both a client node seeking access to resources provided by a server and as a server providing access to hosted resources for other client devices 1406.

Although FIG. 14A shows a network 1405 between the client devices 1406 and the servers 1402, the client devices 1406 and the servers 1402 can be on the same network 1405. In embodiments, there are multiple networks 1405 between the client devices 1406 and the servers 1402. The network 1405 can include multiple networks such as a private network and a public network. The network 1405 can include multiple private networks.

The network 1405 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods e.g., FDMA, TDMA, CDMA, or SDMA. In some embodiments, different types of data can be transmitted via different links and standards. In other embodiments, the same types of data can be transmitted via different links and standards.

The network 1405 can be any type and/or form of network. The geographical scope of the network 1405 can vary widely and the network 1405 can be a body area network (BAN), a personal area network (PAN), a local-area network (LAN), e.g., Intranet, a metropolitan area network (MAN), a wide area network (WAN), or the Internet. The topology of the network 1405 can be of any form and can include, e.g., any of the following: point-to-point, bus, star, ring, mesh, or tree. The network 1405 can be an overlay network which is virtual and sits on top of one or more layers of other networks 1405. The network 1405 can be of any such network topology as known to those ordinarily skilled in the art capable of supporting the operations described herein. The network 1405 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 1405 can be a type of a broadcast network, a telecommunications network, a data communication network, or a computer network.

The network environment 1400 can include multiple, logically grouped servers 1402. The logical group of servers can be referred to as a data center 1408 (or server farm or machine farm). In embodiments, the servers 1402 can be geographically dispersed. The data center 1408 can be administered as a single entity or different entities. The data center 1408 can include multiple data centers 1408 that can be geographically dispersed. The servers 1402 within each data center 1408 can be homogeneous or heterogeneous (e.g., one or more of the servers 1402 or machines 1402 can operate according to one type of operating system platform (e.g., WINDOWS NT, manufactured by Microsoft Corp. of Redmond, Washington), while one or more of the other servers 1402 can operate on according to another type of operating system platform (e.g., Unix, Linux, or Mac OS X)). The servers 1402 of each data center 1408 do not need to be physically proximate to another server 1402 in the same data center 1408 or machine farm. Thus, the group of servers 1402 logically grouped as a data center 1408 can be interconnected using a network. Management of the data center 1408 can be de-centralized. For example, one or more servers 1402 can comprise components, subsystems and modules to support one or more management services for the data center 1408.

Server 1402 can be a file server, application server, web server, proxy server, appliance, network appliance, gateway, gateway server, virtualization server, deployment server, SSL VPN server, or firewall. In embodiments, the server 1402 can be referred to as a remote machine or a node. Multiple nodes can be in the path between any two communicating servers.

FIG. 14B illustrates an example cloud computing environment. A cloud computing environment 1401 can provide client 1406 with one or more resources provided by a network environment. The cloud computing environment 1401 can include one or more client devices 1406, in communication with the cloud 1410 over one or more networks 1405. Client devices 1406 can include, e.g., thick clients, thin clients, and zero clients. A thick client can provide at least some functionality even when disconnected from the cloud 1410 or servers 1402. A thin client or a zero client can depend on the connection to the cloud 1410 or server 1402 to provide functionality. A zero client can depend on the cloud 1410 or other networks 1405 or servers 1402 to retrieve operating system data for the client device. The cloud 1410 can include back-end platforms, e.g., servers 1402, storage, server farms or data centers.

The cloud 1410 can be public, private, or hybrid. Public clouds can include public servers 1402 that are maintained by third parties to the client devices 1406 or the owners of the clients. The servers 1402 can be located off-site in remote geographical locations as disclosed above or otherwise. Public clouds can be connected to the servers 1402 over a public network. Private clouds can include private servers 1402 that are physically maintained by client devices 1406 or owners of clients. Private clouds can be connected to the servers 1402 over a private network 1405. Hybrid clouds can include both the private and public networks 1405 and servers 1402.

The cloud 1410 can also include a cloud-based delivery, e.g., Software as a Service (SaaS) 1412, Platform as a Service (PaaS) 1414, and the Infrastructure as a Service (IaaS) 1416. IaaS can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, e.g., storage, networking, servers or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client devices 1406 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 1406 and server 1402 can be deployed as and/or executed on any type and form of computing device, e.g., a computer, network device or appliance capable of communicating on any type and form of network and performing the operations described herein.

FIG. 14C depicts block diagrams of a computing device 1403 useful for practicing an embodiment of the client 1406 or a server 1402. As shown in FIG. 14C, each computing device 1403 can include a central processing unit 1418, and a main memory unit 1420. As shown in FIG. 14C, a computing device 1403 can include one or more of a storage device 1436, an installation device 1432, a network interface 1434, an I/O controller 1422, a display device 1430, a keyboard 1424 or a pointing device 1426, e.g., a mouse. The storage device 1436 can include, without limitation, a program 1440, such as an operating system, software, or software associated with system shown in FIG. 1.

The central processing unit 1418 is any logic circuitry that responds to and processes instructions fetched from the main memory unit 1420. The central processing unit 1418 can be provided by a microprocessor unit, e.g.: those manufactured by Intel Corporation of Mountain View, California. The computing device 1403 can be based on any of these processors, or any other processor capable of operating as described herein. The central processing unit 1418 can utilize instruction level parallelism, thread level parallelism, different levels of cache, and multi-core processors. A multi-core processor can include two or more processing units on a single computing component.

Main memory unit 1420 can include one or more memory chips capable of storing data and allowing any storage location to be directly accessed by the microprocessor 1418. Main memory unit 1420 can be volatile and faster than storage 1436 memory. Main memory units 1420 can be Dynamic random-access memory (DRAM) or any variants, including static random access memory (SRAM). The memory 1420 or the storage 1436 can be non-volatile; e.g., non-volatile read access memory (NVRAM). The memory 1420 can be based on any type of memory chip, or any other available memory chips. In the example depicted in FIG. 14C, the processor 1418 can communicate with memory 1420 via a system bus 1438.

A wide variety of I/O devices 1428 can be present in the computing device 1403. Input devices 1428 can include keyboards, mice, trackpads, trackballs, touchpads, touch mice, multi-touch touchpads and touch mice, microphones, multi-array microphones, drawing tablets, cameras, or other sensors. Output devices can include video displays, graphical displays, speakers, headphones, or printers.

I/O devices 1428 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 1428, display devices 1430 or group of devices can be augmented reality devices. The I/O devices can be controlled by an I/O controller 1422 as shown in FIG. 14C. The I/O controller 1422 can control one or more I/O devices, such as, e.g., a keyboard 1424 and a pointing device 1426, e.g., a mouse or optical pen. Furthermore, an I/O device can also provide storage and/or an installation device 1432 for the computing device 1403. In embodiments, the computing device 1403 can provide USB connections (not shown) to receive handheld USB storage devices. In embodiments, an I/O device 1428 can be a bridge between the system bus 1438 and an external communication bus, e.g., a USB bus, a SCSI bus, a FireWire bus, an Ethernet bus, a Gigabit Ethernet bus, a Fibre Channel bus, or a Thunderbolt bus.

In embodiments, display devices 1430 can be connected to I/O controller 1422. Display devices can include, e.g., liquid crystal displays (LCD), electronic papers (e-ink) displays, flexile displays, light emitting diode displays (LED), or other types of displays. In some embodiments, display devices 1430 or the corresponding I/O controllers 1422 can be controlled through or have hardware support for OPENGL or DIRECTX API or other graphics libraries. Any of the I/O devices 1428 and/or the I/O controller 1422 can include any type and/or form of suitable hardware, software, or combination of hardware and software to support, enable or provide for the connection and use of one or more display devices 1430 by the computing device 1403. For example, the computing device 1403 can include any type and/or form of video adapter, video card, driver, and/or library to interface, communicate, connect or otherwise use the display devices 1430. In embodiments, a video adapter can include multiple connectors to interface to multiple display devices 1430.

The computing device 1403 can include a storage device 1436 (e.g., one or more hard disk drives or redundant arrays of independent disks) for storing an operating system or other related software, and for storing application software programs 1440 such as any program related to the systems, methods, components, modules, elements, or functions depicted in FIG. 1, or 2. Examples of storage device 1436 include, e.g., hard disk drive (HDD); optical drive including CD drive, DVD drive, or BLU-RAY drive; solid-state drive (SSD); USB flash drive; or any other device suitable for storing data. Storage devices 1436 can include multiple volatile and non-volatile memories, including, e.g., solid state hybrid drives that combine hard disks with solid state cache. Storage devices 1436 can be non-volatile, mutable, or read-only. Storage devices 1436 can be internal and connect to the computing device 1403 via a bus 1438. Storage device 1436 can be external and connect to the computing device 1403 via an I/O device 1428 that provides an external bus. Storage device 1436 can connect to the computing device 1403 via the network interface 1434 over a network 1405. Some client devices 1406 may not require a non-volatile storage device 1436 and can be thin clients or zero client devices 1406. Some storage devices 1436 can be used as an installation device 1432 and can be suitable for installing software and programs.

The computing device 1403 can include a network interface 1434 to interface to the network 1405 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11 a/b/g/n/ac CDMA, GSM, WiMax and direct asynchronous connections). The computing device 1403 can communicate with other computing devices (e.g., servers 1402) via any type and/or form of gateway or tunneling protocol e.g., Secure Socket Layer (SSL) or Transport Layer Security (TLS), QUIC protocol, or the Citrix Gateway Protocol manufactured by Citrix Systems, Inc. of Ft. Lauderdale, Florida. The network interface 1434 can include a built-in network adapter, network interface card, PCMCIA network card, EXPRESSCARD network card, card bus network adapter, wireless network adapter, USB network adapter, modem or any other device suitable for interfacing the computing device 1403 to any type of network capable of communication and performing the operations described herein.

A computing device 1403 of the sort depicted in FIG. 14C can operate under the control of an operating system, which controls scheduling of tasks and access to system resources. The computing device 1403 can be running any operating system configured for any type of computing device, including, for example, a desktop operating system, a mobile device operating system, a tablet operating system, or a smartphone operating system.

The computing device 1403 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 1403 has sufficient processor power and memory capacity to perform the operations described herein. In some embodiments, the computing device 1403 can have different processors, operating systems, and input devices consistent with the device.

In embodiments, the status of one or more machines (e.g., client devices 1406, computing devices 1403) in the network 1405 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 1403 in response to the CPU 1418 executing an arrangement of instructions contained in main memory 1420. Such instructions can be read into main memory 1420 from another computer-readable medium, such as the storage device 1436. Execution of the arrangement of instructions contained in main memory 1420 causes the computing device 1403 to perform the illustrative processes described herein. One or more processors in a multi-processing arrangement may also be employed to execute the instructions contained in main memory 1420. Hard-wired circuitry can be used in place of or in combination with software instructions together with the systems and methods described herein. Systems and methods described herein are not limited to any specific combination of hardware circuitry and software.

Although an example computing system has been described in FIGS. 14A-C, the subject matter including the operations described in this specification can be implemented in other types of digital electronic circuitry, or in computer software, firmware, or hardware, including the structures disclosed in this specification and their structural equivalents, or in combinations of one or more of them.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

1. A system comprising:
a receiver configured to:
receive a first signal comprising data to be communicated from a transmitter to the receiver, the first signal propagated along a first axis of propagation between the transmitter and the receiver in a longitudinal direction; and
receive a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

2. The system of claim 1, wherein the first signal and the second signal are co-propagated along the first axis.

3. The system of claim 1, wherein the second signal is generated by superposing a plurality of beams, each of the plurality of beams having different longitudinal characteristics.

4. The system of claim 3, wherein the plurality of beams comprises a plurality of Bessel beams, and wherein each of the plurality of Bessel beams comprises a different longitudinal wavenumber.

5. The system of claim 1, wherein the second signal is configured to generate an increased signal-to-artificial noise ratio within the region surrounding the location of the receiver relative to a signal-to-artificial noise ratio at other locations along the first axis by:
generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, wherein the signal-to-artificial noise ratio is greater than a threshold value within the region surrounding the location of the receiver.

6. The system of claim 1, wherein a spatial structure of the second signal is randomized by:
modifying one or more transmission parameters of each of a plurality of beams comprising the second signal; and
varying a relative amplitude of each of the plurality of beams comprising the second signal.

7. The system of claim 1, wherein a spatial profile of the first signal is modulated by:
varying one or more of: an amplitude or a transmission parameter of each of a plurality of beams comprising the first signal.

8. The system of claim 1, wherein the receiver is further configured to receive a third signal configured to generate an off-axis signal-to-artificial-noise ratio having a value less than a threshold value to prevent decoding of the first signal.

9. A signal transmitter configured to:
transmit a first signal comprising data to be communicated from the signal transmitter to a receiver, the first signal propagated along a first axis of propagation between the signal transmitter and the receiver in a longitudinal direction; and
transmit a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

10. The signal transmitter of claim 9, wherein the first signal and the second signal are co-propagated along the first axis.

11. The signal transmitter of claim 9, wherein the second signal is generated by superposing a plurality of beams, each of the plurality of beams having different longitudinal characteristics.

12. The signal transmitter of claim 11, wherein the plurality of beams comprises a plurality of Bessel beams, and wherein each of the plurality of Bessel beams comprises a different longitudinal wavenumber.

13. The signal transmitter of claim 9, wherein the second signal is configured to generate an increased signal-to-artificial noise ratio within the region surrounding the location of the receiver relative to a signal-to-artificial noise ratio at other locations along the first axis by:
generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, wherein the signal-to-artificial noise ratio is greater than a threshold value within the region surrounding the location of the receiver.

14. The signal transmitter of claim 9, wherein a spatial structure of the second signal is randomized by:
modifying one or more transmission parameters of each of a plurality of beams comprising the second signal; and
varying a relative amplitude of each of the plurality of beams comprising the second signal.

15. The signal transmitter of claim 9, wherein a spatial profile of the first signal is modulated by:
varying one or more of: an amplitude or a transmission parameter of each of a plurality of beams comprising the first signal.

16. A method comprising:
transmitting, by a transmitter, a first signal comprising data to be communicated from the transmitter to a receiver, the first signal propagated along a first axis of propagation between the transmitter and the receiver in a longitudinal direction; and
transmitting, by the transmitter, a second signal comprising artificial noise, the second signal propagated along the first axis such that a signal-to-artificial noise ratio varies along the first axis in a propagation direction to allow the first signal to be decoded within a region surrounding a location of the receiver and prevent the first signal from being decoded at any other location.

17. The method of claim 16, wherein the first signal and the second signal are co-propagated along the first axis.

18. The method of claim 16, wherein the second signal is generated by superposing a plurality of beams, each of the plurality of beams having different longitudinal characteristics.

19. The method of claim 16, further comprising:
modulating a spatial profile of the first signal by:
varying one or more of: an amplitude or a transmission parameter of each of a plurality of beams comprising the first signal; and
randomizing a spatial structure of the second signal by:
modifying one or more transmission parameters of each of a plurality of beams comprising the second signal; and
varying a relative amplitude of each of the plurality of beams comprising the second signal.

20. The method of claim 16, further comprising:
generating an increased signal-to-artificial noise ratio within the region surrounding the location of the receiver relative to a signal-to-artificial noise ratio at other locations along the first axis by:
generating the second signal from a plurality of Bessel beams, each of the plurality of Bessel beams having a longitudinal wavenumber different than a longitudinal wavenumber of the first signal such that a spatial profile of the second signal overlaps a spatial profile of the first signal at all points along the first axis, wherein the signal-to-artificial noise ratio is greater than a threshold value within the region surrounding the location of the receiver.
